(19) United States
(12) Patent Application Publication
(10) Pub. No.: US 2025/0260021 A1
(43) Pub. Date: Aug. 14, 2025

(54) SYSTEMS AND METHODS FOR 3D PRINTED RANDOMLY INTERPENETRATING ELECTRODES FOR MEMBRANELESS ENERGY STORAGE

(71) Applicant: Lawrence Livermore National Security, LLC, Livermore, CA (US)

(72) Inventors: Cheng ZHU, Dublin, CA (US); Zhen QI, Fremont, CA (US); Longsheng FENG, Dublin, CA (US)

(21) Appl. No.: 18/437,102

(22) Filed: Feb. 8, 2024

(51) Int. Cl. H01M 4/70; H01M 4/13; H01M 4/139; H01M 4/38; H01M 4/50; H01M 4/66; H01M 10/0525

(52) U.S. Cl. CPC H01M 4/70; H01M 4/13; H01M 4/139; H01M 4/38; H01M 4/50; H01M 4/66; H01M 10/0525

(57) ABSTRACT

The present disclosure relates to an energy storage medium apparatus having an electrically conductive anode having a plurality of randomly extending anode portions propagating in three dimensions, and an electrically conductive cathode having a plurality of randomly extending cathode portions propagating in three dimensions. The randomly extending anode portions and the randomly extending cathode portions are interpenetrating in three dimensions while maintaining a separation therebetween.

### FEDERALLY SPONSORED RESEARCH OR DEVELOPMENT

This invention was made with Government support under Contract No. DE-AC52-07NA27344 awarded by the United States Department of Energy. The Government has certain rights in the invention.

### FIELD

The present disclosure relates to energy storage mediums and structures, and more particularly to systems and methods for 3D printing a metal ion battery with a randomly interpenetrating anode and cathode components to create a membrane-less, high density energy storage device.

### BACKGROUND

The statements in this section merely provide background information related to the present disclosure and may not constitute prior art.

Membrane-based metal ion batteries with anode-separator-cathode sandwich configurations have been widely used in various applications, but they also have some drawbacks. First, this type of configuration is only suitable for thin film electrodes based 2D batteries. To increase a cell's energy density, 3D batteries using thick electrodes without separators are highly demanded. For another, such batteries have a limited lifespan. This is because the separator membrane used in membrane-based batteries can degrade over time, reducing the battery's lifespan and leading to potential safety hazards.

Another drawback membrane-based batteries is the reduced power output. The membrane used in these batteries can limit the transport of ions between the anode and cathode, resulting in reduced power output and slower charging. Still another drawback is higher internal resistance. The membrane can also increase the internal resistance of the battery, reducing the overall efficiency and leading to heat generation and decreased performance. Yet still another drawback is limited flexibility: The membrane is a rigid component, which can limit the flexibility of the battery's form factor and restrict its use in certain applications. Still another drawback with membrane-based batteries is a risk of short-circuiting. If the separator membrane is damaged or fails, this condition can lead to a short circuit and potentially cause a thermal runaway, which can to significant battery damage.

Interpenetrating batteries are a type of 3D battery that features a unique interlocking structure to enhance the battery's performance and durability. This type of battery possesses significant advantages over conventional membrane-based batteries. For one, this type of battery provides high energy density. This is because the 3D interlocking structure of the battery allows for increased accessible surface area regardless of the thickness of electrodes, which can increase the amount of active material in the battery, thus resulting in a higher energy density compared to traditional 2D batteries. Another advantage is improved power output. The interlocking structured battery also facilitates better electron and ion transport by removing the membrane separators, resulting in improved power output. Still another advantage of this type of battery is faster charging. 3D interpenetrating batteries can be charged faster compared to traditional batteries due to the short distance between anodes and cathodes with improved electron and ion transport.

Still other advantages and benefits of these batteries are enhanced durability and a more flexible form factor. Regarding enhanced durability, the 3D interlocking structure of the battery provides better mechanical stability, reducing the risk of deformation or damage during use. Regarding a flexible form factor, the interlocking structure of the battery allows for significantly enhanced flexibility in design, making it possible to create batteries of different shapes and sizes to fit a wide range of applications.

In spite of the foregoing advantages of interpenetrating batteries, there is a strong interest in further improving the performance of current interpenetrating energy storage devices, and particularly those batteries that interweave periodic/ordered structures as separate anodes and cathodes unit cells.

### SUMMARY

This section provides a general summary of the disclosure, and is not a comprehensive disclosure of its full scope or all of its features.

In one aspect the present disclosure relates to an energy storage medium apparatus. The apparatus may comprise an electrically conductive anode having a plurality of randomly extending anode portions propagating in three dimension and an electrically conductive cathode. The electrically conductive cathode may have a plurality of randomly extending cathode portions propagating in three dimensions. The randomly extending anode portions and the randomly extending cathode portions are interpenetrating in three dimensions while maintaining a separation therebetween.

In another aspect the present disclosure relates to a lithium-ion energy storage medium apparatus. The apparatus may comprise an electrically conductive anode having a plurality of randomly extending and randomly shaped anode portions propagating in three dimensions, and an electrically conductive cathode. The electrically conductive cathode has a plurality of randomly shaped and randomly extending cathode portions propagating in three dimensions. The randomly extending anode portions and the randomly extending cathode portions are interpenetrating in three dimensions while maintaining a separation therebetween.

In still another aspect the present disclosure relates to a method for forming a 3D energy storage apparatus. The method may comprise forming an electrically conductive anode having a plurality of randomly extending anode portions propagating in three dimensions. The method may further comprise forming an electrically conductive cathode having a plurality of randomly extending cathode portions propagating in three dimensions. The randomly extending anode portions and the randomly extending cathode portions are further formed so as to interpenetrate in three dimensions while maintaining a separation therebetween.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

Corresponding reference numerals indicate corresponding parts throughout the several views of the drawings.

FIG. 1 is an illustration of a prior art, interpenetrating, ordered structure formed by a face-centered cubic structure and a Rhombic Dodecahedron;

FIG. 2 is a high level view of one example of an photostereolithography AM printing system that may be used to construct a battery with randomly interpenetrating anode and cathode components, in accordance with the present disclosure;

FIG. 3 is a simulation, 2D view of a spinodal structure created by mimicking phase separation, where randomly interpenetrating anode and cathode components are created;

FIG. 4 is a simulation showing a perspective 3D view of a spinodal structure created by mimicking phase separation, where the randomly interpenetrating nature of the two phases propagating in three dimensions is clearly visible;

FIGS. 5a and 5b show simulation perspective views of anisotropic spinodal structure, illustrating the possibility of tuning directionality of anode and cathode while still providing randomly interpenetrating anode and cathode structures;

FIG. 6a show perspective views of a test printed anode and a test printed cathode with randomly extending anode and cathode features, respectively;

FIG. 6b shows a single test printed structure that incorporates the anode and cathode structures shown in FIG. 6a, illustrating the random interpenetrating configuration of the anode and cathode, and where the single test printed structure is shown from two different perspectives;

FIG. 7a shows a test printed anode and separate test printed cathode with randomly extending anode and cathode features, respectively;

FIG. 7b shows a single test printed structure that incorporates the anode and cathode structures shown in FIG. 7a, illustrating the random interpenetrating configuration of the anode and cathode, and where the single test printed structure is shown from two different perspectives; and

FIG. 8 is a high level flowchart illustrating a plurality of operations that may be performed.

### DETAILED DESCRIPTION

Example embodiments will now be described more fully with reference to the accompanying drawings.

The present disclosure relates broadly to energy storage devices, and more particularly to energy storage devices which incorporate 3D random, interdigital architectures, as well as fabrication processes therefor. The present disclosure involves creating 3D random interdigital architectures with anodes and cathodes, eliminating the need for a membrane to separate them. The new methods of construction discussed herein may in some implementations employ Stereolithography (SLA) 3D printing technology to print the structures. Printing may be followed by rinsing the structure with organic solutions to remove residual printing resin. The cleaned structures may then be solidified by curing with UV light. In some embodiments a conductive layer is introduced through an electroless plating process for surface modification, and active materials like copper and MnO₂ are deposited onto both sides of the anode and cathode. Unlike direct ink writing techniques, this method allows for the creation of significantly more complex structures, allowing for significantly improved design and tuning of the battery's performance.

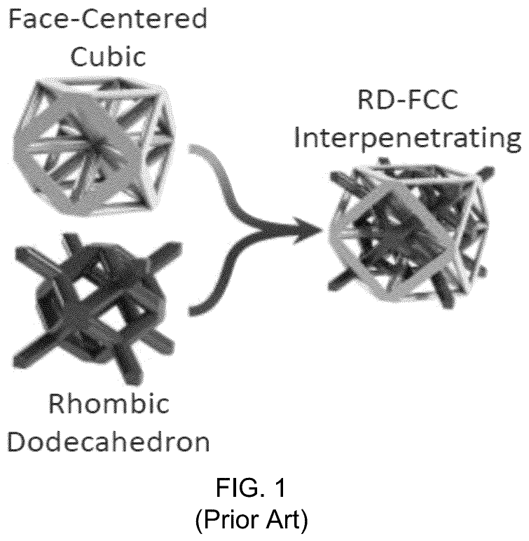

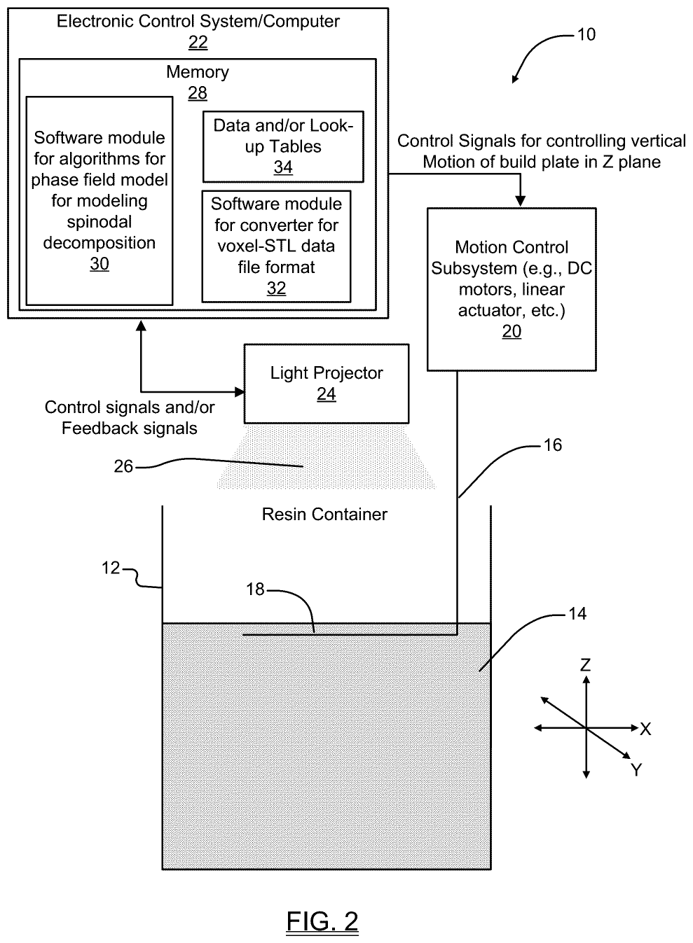

Referring to FIG. 1, one example of a photostereolithography system 10 in accordance with the present disclosure for creating a battery having a randomly interpenetrating anode and cathode, which randomly interpenetrate and propagate in three dimensions, is shown. In this example the system 10 includes a resin container 12 filled with a photoresponsive resin (e.g., “photoresist”) 14. A build plate 16 having a build surface 18 projects partially into the resin 14. A motion control subsystem 20 may be led to control motion along a Z axis, to enable the build surface 18 to be lowered incrementally deeper into the resin 14 as a 3D part is formed in a layer-by-layer process, as is well understood with photostereolithography systems.

The motion control subsystem 20 shown in FIG. 1 may be controlled by an electronic control system/computer 22 (hereinafter simply “electronic control system 22”). The electronic control system 22 may be used to supply control signals to the motion control subsystem 20 to help control sequential, step-by-step lowering of the build surface 18 as each distinct layer of the 3D part is formed. The electronic control system 22 may also supply image information 26 to a light projector 24 to enable the light projector to generate 2D images associated with each layer of the 3D part being constructed into the resin 14. The light projector 24 may be any type of light projector suitable for projecting 2D image information for the formation of a layer of a 3D part (e.g., via projection micro-stereolithography). The electronic control system 22 may include a memory 28 (RAM/ROM/EPROM/EEPROM/DRAM, etc.), for storing one or more software modules and/or data files, look-up tables, etc. The memory 28 need not be part of the electronic control system 22 but may be a fully separate component that is accessible by the electronic control system 22. In this example the memory 28 is shown as part of the electronic control system 22, and in some embodiments includes one or more of a software module 30 for containing algorithms for carrying out a phase field model for modeling spinodal composition. In some embodiments another software module 32 may be included which includes a converter module for converting voxel-based data generated by the phase field model into an STL (Standard Triangle/Tessellation Language) based file commonly used in 3D photostereolithography printing systems. Optionally, in some embodiments, additional memory file 34 may be included to hold one or more data files, data tables, look-up tables, performance curves, historical information of previously made 3D parts, and other information that would be valuable or helpful to have available for use in a 3D photostereolithography printing process.

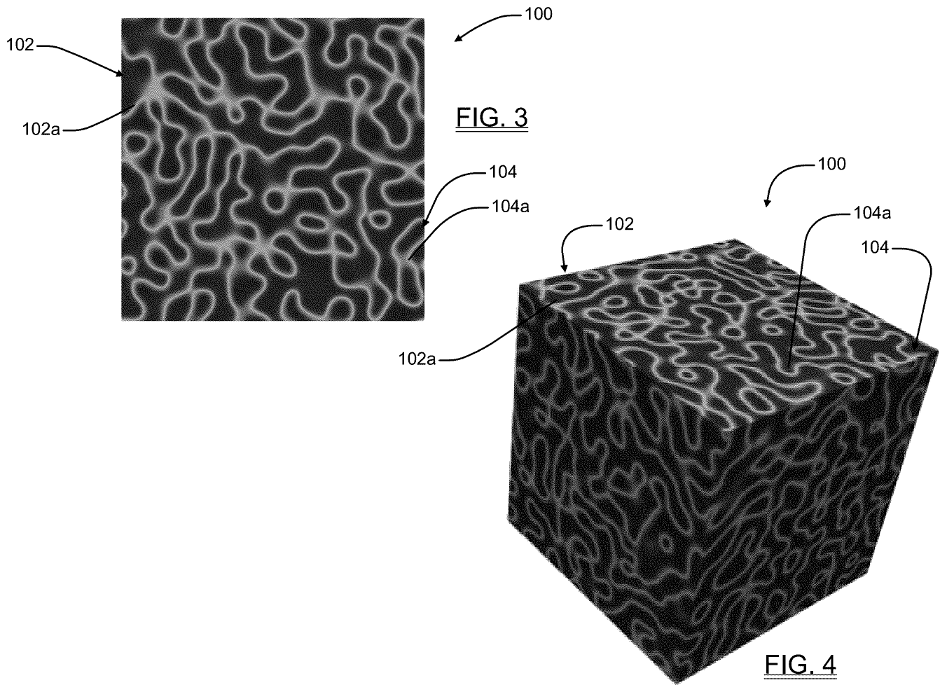

Referring to FIGS. 3 and 4, one example of an energy storage medium 100 in accordance with the present disclosure is shown. In specific example the energy storage medium 100 may form a battery or a portion of a battery. FIG. 3 is a plan view and FIG. 4 is a perspective view of the energy storage medium 100. The energy storage medium 100 includes a cathode 102 made up of randomly shaped cathode portions 102a which extend randomly in three dimensions, and an anode 104 made up of a plurality of randomly shaped anode portions 104a which extend randomly in three dimensions. The cathode portions 102a and anode portions 104 are arranged in a randomly interpenetrating configuration which propagates in three dimensions throughout the volume of the battery 100. A minimum spacing between the cathode portions 102 and anode portions 104 may be defined using the phase model, as will be described in greater detail in the following paragraphs.

A significant and principal feature of the energy storage medium is that no separator element is needed to separate the cathode and anode portions 102a and 104a, respectively. The ability to construct the energy storage medium 100 with a predefined, minimum spacing between the cathode and anode portions 102a/104a reduces or eliminates a number of significant drawbacks with membrane-based energy storage devices such as lithium-ion batteries. The membrane can limit the flow of ions between the anode 104 and the cathode 102, resulting in reduced power output and slower charging. Still another drawback of the membrane is higher internal resistance of the battery. The membrane can also increase the internal resistance of the battery, reducing the overall efficiency and leading to heat generation and decreased performance. And still another drawback is limited flexibility, because the membrane is a rigid component which can limit the flexibility of the battery's form factor and restrict its use in certain applications. These are but a few of the limitations or drawbacks imposed by the inclusion of a membrane in a battery.

The 3D interpenetrating structure of the energy storage medium 100 discussed herein also provides increased surface area, which allows for higher energy density and improved power output. The 3D interpenetrating architecture also facilitates enhanced electron and ion transport, resulting in even faster charging and significantly improved overall efficiency. Additionally, the 3D interlocking structure provides better mechanical stability, reducing the risk of deformation or damage during use. This invention has the potential to improve energy storage technology, making it safer, more efficient and longer-lasting.

Mathematical Algorithm for Creating Interpenetrating Anode and Cathode

The present disclosure makes use of one or more algorithms which ensure that the cathode and anode within a 3D energy storage medium are randomly interpenetrated, while at the same time maintaining a user selected minimum distance from one another (i.e., maintaining at least a minimum predefined distance or spacing from one another). Several important requirements for such an energy storage medium are as follows: 1) the domains of cathode and anode are random; 2) the cathode and anode need to be interpenetrating in three dimensions; and 3) the cathode and anode need to be separated with a controllable distance.

The present disclosure utilizes spinodal decomposition modeled by phase field methods to generate the 3D energy storage medium 100 described above. The spinodal decomposition mechanism generates randomly interpenetrating, two-phase microstructure, and the phase field methods can perfectly model this phenomenon. In addition, the diffuse interface nature of the phase field method can also help tune the distance between the two phases.

The phase field model employed by the present disclosure for modeling spinodal decomposition can be described as two steps:

1) Write the free energy for the entire computational domain as a function of concentration (Eqn. (1)). The Ac²(1−c)² is a double-well type function with the prefactor “A” controlling the height of the double well. It will be appreciated by those skilled in this art that a “double-well” function is a general description of a curve that has two local minimum with one local maximum in between. The height of the double well refers to the local maximum with respect to the local minimums. The variable “κ” is the gradient energy coefficient which captures the contribution of the concentration gradient ∇c to the overall free energy.

$$F = \int [ A {{c}^{2} ( 1 - c )}^{2} + {κ ( ∇ c )}^{2} ] d V , \qquad ( 1 )$$

2) The concentration field evolves according to Cahn-Hilliard equation (Eqn. (2)), assuming the mobility (M) is constant. The “mobility” (M) constant describes how fast the system evolves following Cahn-Hilliard dynamics. Physically, it relates to the diffusivity of atoms/molecules in a given system. For the present disclosure, this may be a dummy variable that allows one to control how fast the domains are evolving, so that one can stop the simulation at a desired domain size. The Cahn-Hilliard equation, with the mobility (M) constant being constant, may be expressed as:

$$\frac{\partial c}{\partial t} = ∇ \cdot M ∇ \frac{\partial F}{\partial c} = M {∇}^{2} \frac{\partial F}{\partial c} , \qquad ( 2 )$$

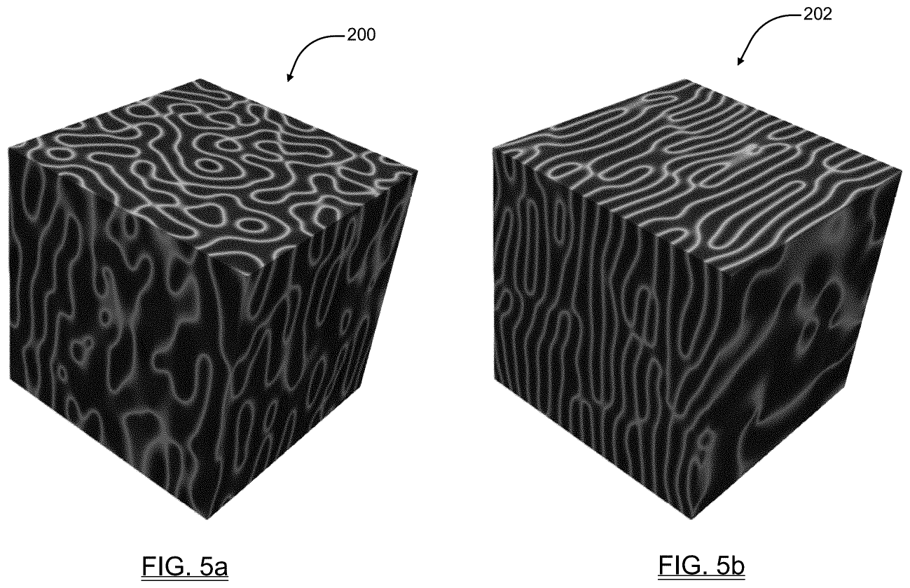

Then the computational domain evolves into a c-rich phase and a c-poor phase, which are randomly interpenetrating in three dimensions. By tuning both the double-well height and gradient energy coefficient, the distance between the two phases can be controlled. To add anisotropy to the domain structures, one would add directional driving forces to specifically favor one or more directions. There are many ways to achieve this, for example and without limitation, by adding elastic anisotropy, interfacial anisotropy, external field anisotropy, etc. Here, for simple implementation and control, one may add an artificial electric field to induce anisotropy. The free energy contribution to the computational domain from the electric field can be written as F^{electric}=0.5*J(εE²)dV, where ε is the dielectric constant and E is the electric field, both of which could be a function of the spatial location in the computational domain, and the dielectric constant is also a function of the concentration c. To generate the structure in FIG. 5(a), a uni-axial electric field is applied and the dielectric constant is assumed to be a quadratic function of concentration c. This results in anode/cathode domains elongated toward the applied electric field direction, making their domains columnar. If two directions are applied with the electric field of the same magnitude, one obtains FIG. 5(b), where the anode/cathode domains are lamellar. One could design the electric field as well as the dielectric constant to obtain other or more complicated anisotropies.

Referring briefly to FIGS. 5a and 5b, two structures 200 and 202 are shown to illustrate columnar and lamellar energy storage structures, respectively, that may be formed using the above described phase field modeling of spinodal decomposition.

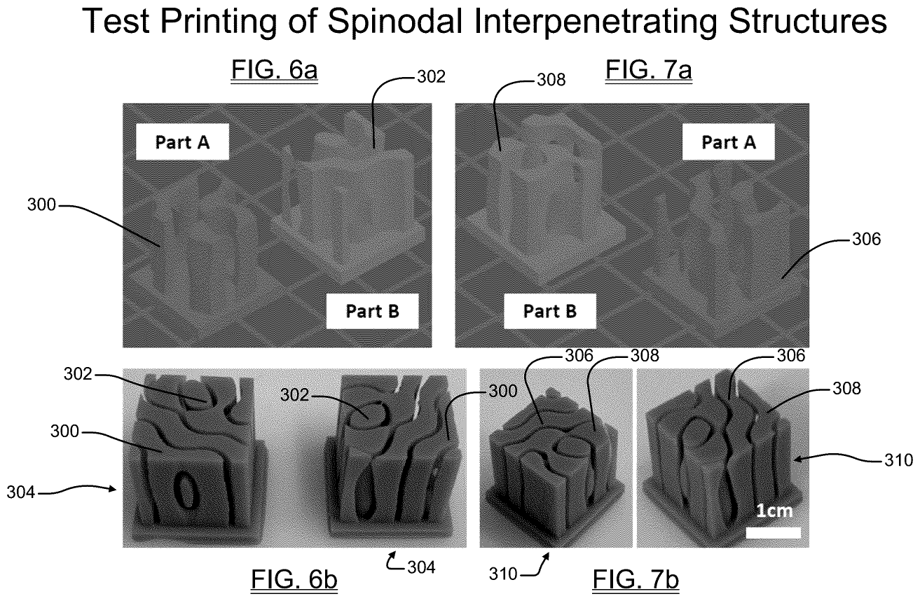

FIG. 6a shows an example of an anode 300 and a cathode 302 which were 3D printed separately as a test using a standard photostereolithography system. FIG. 6b shows two different perspective views of a single structure 304 that was printed in accordance with the teachings of the present disclosure, which combines parts anode 300 and cathode 302 into the single structure 304. FIG. 7a similarly shows another test print of an anode 306 and a cathode 308, while FIG. 7b shows a test printed single structure 310 which combines the anode 306 and the cathode 308 into a single structure 310. Again, in the structure 310 the anode and the cathode interpenetrate in a random fashion and propagate randomly in 3D space.

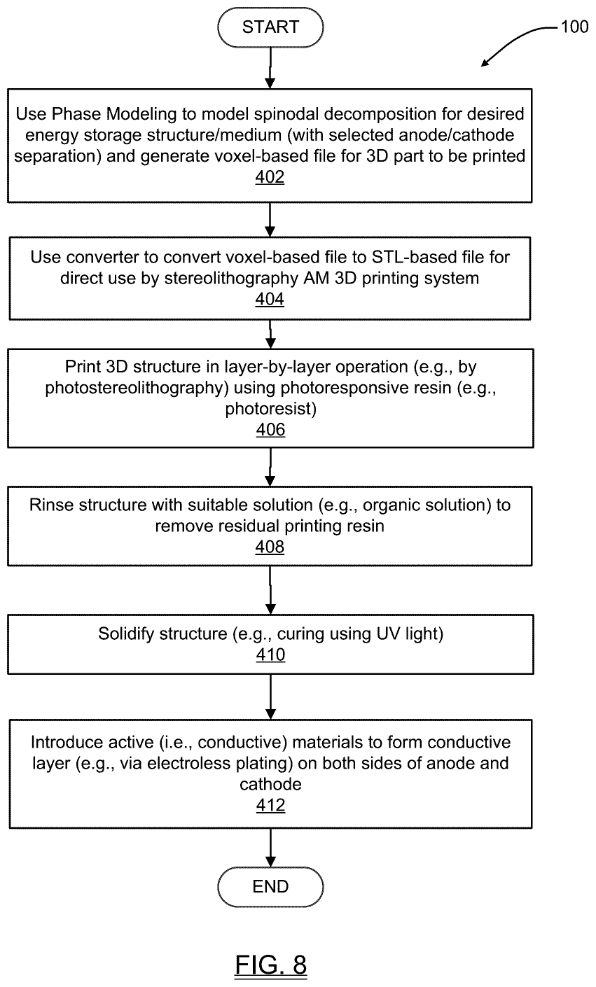

Referring to FIG. 8, a high level flowchart 400 is shown of various operations that may be performed by the system 10 in carrying out the manufacture of an energy storage medium with a randomly penetrating anode and cathode (e.g., lithium-ion battery with randomly interpenetrating anode and cathode). Initially at operation 402 phase modeling to model the spinodal decomposition for a desired energy storage medium is carried out. This operation generates a voxel-based data file for the 3D part (e.g., energy storage medium) to be printed. At operation 404 a commercially available data converter is then used to convert the voxel-based data file to a STL-based file (i.e., Standard Tessellation Language based file). At operation 406 the 3D structure is printed in a layer-by-layer operation using the photostereolithography system 10 to create the part from the photoresponsive resin. At operation 408 the just-printed 3D structure is rinsed with a suitable solution (e.g., organic solution) to remove residual printing resin. At operation 410 the just-rinsed 3D structure may be solidified, in one manner by curing with UV light for a suitable predetermined time period, for example 2-4 hours. At operation 412 electrically conductive materials may be introduced to form conductive layers (e.g., via electroless plating) on both sides of each of the anode and cathode. In some embodiments the electrically conductive materials may comprise, without limitation, copper, manganese dioxide (MnO₂), zinc, nickel, iron, gold, silver or cobalt. In some embodiments further operations may be performed to tailor the newly created 3D structure for a specific application.

The present disclosure thus provides an energy storage medium and methods for manufacture thereof, where the medium has randomly interpenetrating anode and cathode structures with a predesigned minimum separation between the anode and cathode structures. The energy storage medium embodiments presented herein and the methods of manufacture presented herein significantly improve upon the performance of traditional interdigital lithium-ion batteries, while still providing a wide range of design capabilities to provide anisotropic and isotropic anode and cathode configurations, to thus meet a wide range of needs and applications. Unlike other AM manufacturing processes, for example direct ink writing techniques, the methods described herein allow for the creation of even more complex structures, allowing for finer tuning of a battery's performance.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. As used herein, the term “about”, when used immediately previous to a specific recited value, denotes the specific recited value as well as all values, inclusive, from +/−10% of the specific recited value.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. An energy storage medium apparatus, the apparatus comprising:
an electrically conductive anode having a plurality of randomly extending anode portions propagating in three dimensions;
an electrically conductive cathode having a plurality of randomly extending cathode portions propagating in three dimensions; and
the randomly extending anode portions and the randomly extending cathode portions being interpenetrating in three dimensions while maintaining a separation therebetween.

2. The apparatus of claim 1, wherein:
the randomly extending anode portions are randomly shaped; and
the randomly extending cathode portions are randomly shaped.

3. The apparatus of claim 1, wherein the electrically conductive anode includes an electrically conductive coating on opposing surfaces thereof.

4. The apparatus of claim 1, wherein the electrically conductive cathode includes an electrically conductive coating on opposing surfaces thereof.

5. The apparatus of claim 1, wherein the electrically conductive anode comprises a resin coated with an electrically conductive coating.

6. The apparatus of claim 1, wherein the electrically conductive anode comprises a resin coated with an electrically conductive coating.

7. The apparatus of claim 1, wherein:
the electrically conductive anode comprises a photoresponsive resin coated with an electrically first conductive coating; and
the electrically conductive cathode comprises a photoresponsive resin coated with a second electrically conductive coating.

8. The apparatus of claim 1, wherein the first and second electrically conductive coatings comprise at least one of copper, manganese dioxide MnO₂, zinc, nickel or iron.

9. A lithium-ion energy storage medium apparatus, the apparatus comprising:
an electrically conductive anode having a plurality of randomly extending and randomly shaped anode portions propagating in three dimensions;
an electrically conductive cathode having a plurality of randomly shaped and randomly extending cathode portions propagating in three dimensions; and
the randomly extending anode portions and the randomly extending cathode portions interpenetrating in three dimensions while maintaining a separation therebetween.

10. The apparatus of claim 9, wherein the anode and cathode are formed from a photoresponsive resin.

11. The apparatus of claim 9, wherein each of the
the electrically conductive anode comprises a photoresponsive resin coated with an electrically first conductive coating; and
the electrically conductive cathode comprises a photoresponsive resin coated with a second electrically conductive coating.

12. The apparatus of claim 11, wherein the first conductive coating comprises at least one of copper, manganese dioxide (MnO₂), zinc, nickel or iron.

13. The apparatus of claim 11, wherein second conductive coating comprises at least one of copper, manganese dioxide (MnO₂), gold, silver or cobalt.

14. The apparatus of claim 9, wherein:
the electrically conductive anode comprises a photoresponsive resin coated with an electrically first conductive coating; and
the electrically conductive cathode comprises a photoresponsive resin coated with a second electrically conductive coating.

15. A method for forming a 3D energy storage apparatus, the method comprising:
forming an electrically conductive anode having a plurality of randomly extending anode portions propagating in three dimensions; and
forming an electrically conductive cathode having a plurality of randomly extending cathode portions propagating in three dimensions, and such that the randomly extending anode portions and the randomly extending cathode portions interpenetrate in three dimensions while maintaining a separation therebetween.

16. The method of claim 15, wherein the randomly extending anode portions are also randomly shaped.

17. The method of claim 15, wherein the randomly extending cathode portions are also randomly shaped.

18. The method of claim 15, wherein a configuration of the randomly extending anode portions and a configuration of the randomly extending cathode portions are initially generated using a phase field model to model spinodal decomposition while providing a user selected minimum separation between the anode portions and the cathode portions, and to generate a voxel-based file for the 3D energy storage apparatus.

19. The method of claim 18, further comprising using a converter to convert the voxel-based data file to a Standard Triangle/Tessellation Language (STL) file for use by a 3D printing system.

20. The method of claim 15, wherein the electrically conductive anode and the electrically conductive cathode are formed:
first from a photoresponsive resin in a photostereolithography process; and
surfaces of each are subsequently each coated with a conductive material of at least one of copper, manganese dioxide, gold, nickel, iron, silver or cobalt.
